(19) United States
(12) Patent Application Publication
(10) Pub. No.: US 2023/0391647 A1
(43) Pub. Date: Dec. 7, 2023

(54) Method for eliminating legionellae from water of a cooling circuit, which is loaded with organic substances and inorganic particles

(71) Applicant: SMS group GmbH, Düsseldorf (DE)

(72) Inventor: Angela ANTE, Dattenberg (DE)

(73) Assignee: SMS group GmbH, Düsseldorf (DE)

(21) Appl. No.: 18/249,117

(22) PCT Filed: Sep. 6, 2021
(86) PCT No.: PCT/EP2021/074461

§ 371 Date: Apr. 14, 2023

(30) Foreign Application Priority Data
Oct. 16, 2020 (DE) 10 2020 213 078.7

(51) Int. Cl. C02F 3/34; C02F 5/08; C02F 1/00; C10M 175/00; C10M 175/04

(52) U.S. Cl. CPC C02F 3/348; C02F 3/343; C02F 5/08; C02F 1/004; C10M 175/0058; C10M 175/04; C02F 2305/06; C02F 2303/22; C02F 2301/046; C02F 2103/023

(57) ABSTRACT

A method for eliminating legionellae from water of a cooling circuit of industrial plants, in particular of a hot rolling mill, is disclosed. The water is loaded with organic substances and inorganic particles. In a further aspect, the use of bacteria for eliminating legionellae from a water of a cooling circuit of an industrial plant is disclosed.

### CROSS-REFERENCE TO RELATED APPLICATION

This application is a national stage application, filed under 35 U.S.C. § 371, of International Patent Application No. PCT/EP2021/074461, filed on 6 Sep. 2021, which claims the benefit of German Patent Application No. 10 2020 213 078.7, filed 16 Oct. 2020.

### BACKGROUND

In industrial plants, especially in a hot rolling mill, large quantities of water are required to cool the process line. During the cooling process, such water becomes loaded with organic components, such as oils and fats, and inorganic particles, such as scale. Thereby, the organic components cause deposits in the cooling circuit, which have to be removed at regular intervals and disposed of separately. This significantly increases the ongoing operating costs of the respective plant.

Legionellae contamination of the cooling circuits is also a problem. In particular, aerosols have been identified as the source of legionellae contamination in open cooling circuits, i.e. cooling circuits with open cooling towers, which is why the 42nd Regulation of the Federal Emissions Control Act (Bundes-Immissionsschutzgesetz) of the Federal Republic of Germany was enacted. This regulates, among other things, the permissible legionellae limit values in water.

In order to reduce the legionellae concentration in the water of the cooling circuit when the permitted limit values are exceeded, a biocide or a biocide mixture is added to it. This shows that no significant legionellae concentrations can be detected after biocide dosing, but this is only temporary.

Legionellae is known to develop in amoebae as host organisms that live in biofilms. Thereby, the biofilms form a biotope of their own for the microorganisms that colonize them and provide extremely effective protection against harsh conditions. The organic components present in the water of the cooling circuit also facilitate the formation of the biofilms, which means that the microorganisms living in them prove to be particularly resistant to biocides. Therefore, biocide dosing only kills the so-called free and unprotected microorganisms in the water. The microorganisms protected in the biofilms, on the other hand, survive the biocide measure almost unscathed, such that after a few days to weeks, legionellae bacterial counts that in some cases considerably exceed the count prior to biocide dosing are regularly achieved.

In principle, legionellae are only infectious if they enter the lungs. Therefore, legionellae represent a particularly high hazard potential for the operating personnel at all rolling operations of a process line that require direct cooling and thus release aerosols to a considerable extent. Therefore, in particular the working positions at cooling sections, the work roll cooling systems and the scale washers of hot rolling mills represent a high hazard potential.

### SUMMARY

The present disclosure relates to a method for eliminating legionellae from water of a cooling circuit of industrial plants, in particular of a hot rolling mill, which is loaded with organic substances and inorganic particles, and in a further aspect to the use of bacteria for eliminating legionellae from a water of a cooling circuit of an industrial plant.

It has become apparent that there is still a need for methods that are able to guarantee legionellae concentrations or legionellae bacterial counts, as the case may be, below the prescribed limits.

As such, the present disclosure is based on the object of providing a method that overcomes the disadvantages of the prior art. In particular, the present disclosure is based on the object of providing a method that ensures that the legionellae concentration or legionellae bacterial counts, as the case may be, in the water of the cooling circuit are below the prescribed limit values.

The task is solved with the features as disclosed and claimed.

Advantageous embodiments of the invention are indicated in the dependent formulated claims. The features listed individually in the dependent formulated claims can be combined with one another in a technologically useful manner and may define further embodiments of the invention. In addition, the features indicated in the claims are further specified and explained in the description, wherein further preferred embodiments of the invention are illustrated.

A method is proposed for eliminating legionellae from water of a cooling circuit of industrial plants, in particular of hot rolling mills, which is loaded with organic substances and/or inorganic particles, with which the water of the cooling circuit is initially passed in a cooling circuit at least via a separation device for separating the organic substances and/or the inorganic particles from the water of the cooling circuit, and via an open cooling tower arranged downstream of the separation device for cooling the circuit water. At least one position of the cooling circuit, bacteria are added to the water of the cooling circuit, which bacteria are suitable for degrading the organic substances present in the water of the cooling circuit and which form a biological purification stage within the cooling circuit, in such a manner that, in a steady state, a legionellae limit value in the water of the cooling circuit of a maximum of 100 CFU/ml is achieved.

Surprisingly, it has been shown that by adding the bacteria to the water of the cooling circuit of an industrial plant, in particular of a hot rolling mill, the prescribed legionellae limit value can be sustainably reduced and maximum values of 100 CFU/ml, preferably of maximum 70 CFU/ml, particularly preferably of maximum 40 CFU/ml, more preferably of maximum 10 CFU/ml and most preferably of maximum 1 CFU/ml are then achieved in the water of the cooling circuit.

The present disclosure is based on the essential finding that the addition of the bacteria specialized in the degradation of organic matter, such as oils and fats, permanently removes the resistant biofilms in the cooling circuit, which in such a manner also form the breeding ground for legionellae.

The bacteria added to the cooling circuit form biocenoses in one or more regions of the cooling circuit, in which the bacteria settle and break down or metabolize the organic substances, in particular the oils and fats, which are responsible for the formation of the particularly resistant biofilms. Once a steady state is achieved, only the bare scale particles remain in the water of the cooling circuit, which particles may be removed, for example, gravimetrically or, due to the ferromagnetic properties, by means of magnetic separation at a suitable point in the cooling circuit.

For example, a granulate available from the applicant under the product name “Oilco-Bacteria” can be used as the bacterial culture.

A biocenosis within the meaning of the present invention is a community of organisms in a delimited habitat (biotope), wherein the biocenosis and the biotope together form an ecosystem.

In an advantageous embodiment, the bacteria are added to the water of the cooling circuit upstream of and/or within the separation device and/or upstream of the cooling tower. The bacteria may thus be added to the water of the cooling circuit locally, or preferably distributed over the entire cooling circuit, in order to form the biological purification stage. When the bacteria are added throughout the entire cooling circuit, the advantage is that any aggregates in the cooling circuit remain largely free of the sticky organic deposits that would normally have to be removed from the entire cooling circuit at regular intervals and disposed of separately. The removal of such deposits, which include the organic substances along with the inorganic particles, can thus be saved, which has a beneficial effect on the ongoing operating costs of the plant.

In an additional preferred embodiment, nutrients are added to the water of the cooling circuit upstream of the separation device and/or upstream of the cooling tower to promote the growth of the added bacteria. The added nutrients promote the formation of the biocenosis by the bacteria and further favor its long-term existence. Preferably, it is thereby provided that the ratio of added bacteria to added nutrients is reduced over time. In this connection, it is particularly preferred that the bacteria are added as a function of the formation of the biocenosis. For the initial formation of biocenosis in a cooling circuit, a higher concentration of bacteria is beneficial. Thus, a particularly preferred mixture of added bacteria and added nutrients contains 1% by weight of bacteria and 99% by weight of nutrients. On the other hand, to maintain an already formed biocenosis, an increased nutrient concentration is beneficial. Thus, the concentration of added bacteria decreases below 1% by weight with increasing application time, while simultaneously adding over 99% by weight of nutrients.

The bacteria are pure cultures of species that specifically degrade oil and fat. Some should be able to grow under anaerobic environmental conditions to exist in a settling basin and deeper layers of a clarifying basin, other species must be able to live aerobically to be able to remove oils and fats in the cooling tower and on the surface of the clarifying basin as well.

The nutrients comprise primarily nitrogen and phosphorus, although sulfur, potassium, magnesium and/or sodium may also be present. A micronutrient blend can also be a component of the concentrate. This comprises a mixture of metals such as copper, nickel, cobalt, manganese, molybdenum, tungsten, zinc and/or tungsten, possibly supplemented by boron, silicon and/or selenium and possibly other elements and/or amino acids. The iron usually contained in bacterial media is not necessary, as it is present in the cooling circuit in sufficient concentration; this applies in the same way to calcium.

In an additional advantageous embodiment, the bacteria and/or the nutrients are provided in the form of a granulate and are added to the water of the cooling circuit within a cooling circuit in the form of an aqueous solution. The granules contain the bacteria and/or the nutrients in a concentrated form, such that the storage requirement is reduced. Conveniently, the granules are dissolved in water. For this purpose, the water is advantageously initially heated to a temperature comparable to that of the water of the cooling circuit. Then, the granules are added and the solution is prepared. After a maturing time of 3 to 6 h, the solution is added to the water of the cooling circuit. This has been shown to significantly improve the dissemination of bacteria and/or nutrients in the cooling circuit. In this connection, it is further preferably provided that the bacteria in the granules are lyophilized bacteria. Lyophilized bacteria (freeze-dried bacteria) have a significantly higher shelf life, such that the granules can be stored for longer periods.

In an alternative embodiment, the bacteria and/or nutrients may be provided in the form of a suspension. In such a case, the bacteria are grown in a bioreactor and added directly to the water of the cooling circuit without lyophilization. Due to the short shelf life of the bacterial and/or nutrient suspension, the bioreactor should be arranged close to the cooling circuit.

In a further preferred embodiment, the water of the cooling circuit loaded with the organic substances and the inorganic particles is passed within the separation device through a settling basin, a clarifying basin and/or a filtration purification device. In this connection, it is particularly preferred that the bacteria are added to the settling basin and/or the clarifying basin. Very preferably, it is provided that the bacteria are added to the water of the cooling circuit with different milieu requirements, in particular anaerobic, aerobic and/or anoxic. The bacteria spread according to the respective environment, thereby attaching themselves to the surfaces of the plant components and to the scale particles of the sludge separated and collected from the aggregates, thus forming a biocenosis in the respective plant components.

The invention is not limited to plants of the hot rolling mill described in more detail here, but can in principle also be applied in other branches of industry, such as plants of the food industry, refineries, the chemical industry along with the pharmaceutical industry. The prerequisite here is contamination with organic compounds, such as by means of hydrocarbons, proteins or carbohydrates, such that the cooling circuits are thus exposed to the risk of legionellae infestation.

The invention and the technical environment are explained in more detail below with reference to the figures. It should be noted that the invention is not limited by the exemplary embodiments shown, and thus is intended solely for the purpose of understanding the invention. In particular, unless explicitly shown otherwise, it is also possible to extract partial aspects of the facts explained in the figures and combine them with other components and findings from the present description and/or figures. In particular, it should be noted that the figures and especially the size relationships shown are only schematic. Identical reference signs designate identical objects, such that explanations from other figures may be used as a supplement if necessary.

### BRIEF DESCRIPTION OF THE DRAWINGS

FIG. 1 is a schematic illustration of a plant for eliminating legionellae from water of a cooling circuit loaded with organic substances and inorganic particles in one embodiment.

### DETAILED DESCRIPTION

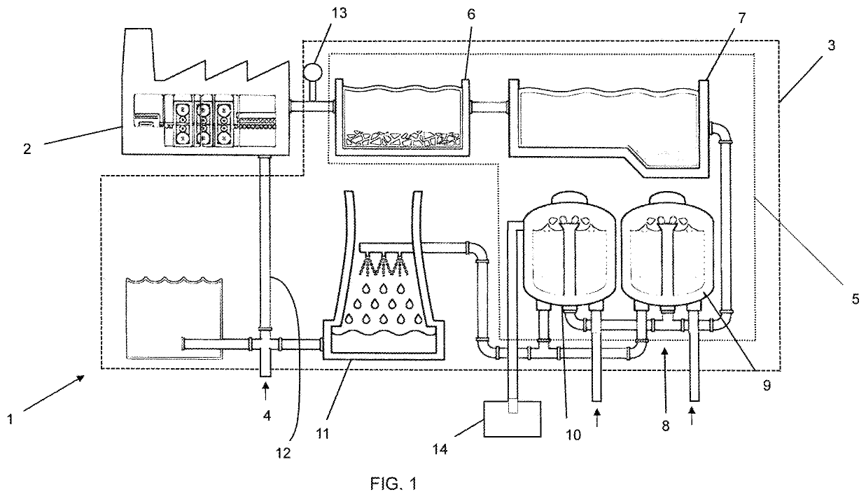

In the embodiment shown here, the plant 1 shown in FIG. 1 comprises a hot rolling mill 2 that is adjoined by a cooling circuit 3. The cooling circuit 3 comprises a plurality of aggregates, each of which is fluidically interconnected and will be explained in more detail below.

As shown, the hot rolling mill 2 is initially coupled to the cooling circuit 3, such that water of a cooling circuit loaded in the hot rolling mill 2 with organic substances, such as oils and greases, along with inorganic particles, such as scale in particular, is treated by the aggregates arranged in the cooling circuit 3 to such an extent that it can be fed directly back to the hot rolling mill 2. If the quantity of water of the cooling circuit should fall below a specific volume, additional fresh water can be added to the cooling circuit 3 via a fresh water inlet 4.

The plant 1 shown in FIG. 1 initially comprises a separation device 5 for separating the organic substances and the inorganic particles from the water of the cooling circuit of the hot rolling mill 2, such that a pre-purified water of the cooling circuit is obtained. As can be seen from FIG. 1, the separation device 5 comprises a plurality of components connected in series.

In the present embodiment, the separation device 5 comprises a settling basin 6 for separating a coarse fraction of a mixture of organic substances and inorganic particles, a clarifying basin 7 for separating an average size of the mixture of organic substances and inorganic particles and for sucking away free oil from the surface, and finally a filtration device 8, which generally comprises a plurality of filtration units.

It should be noted that, in the present embodiment, only two filtering units 9, 10 of the plurality of filtering units of the filtering device 8 connected in parallel are shown as examples. In the filtration device 8, a fine fraction of the mixture of organic substances and inorganic particles is separated. Both filtration units 9, 10 of the filtration device 8 are designed to be able to be backflushed and are connected to a gravel filter sludge buffer 14. In the present case, the filtration units 9, 10 are designed in the form of a gravel filter.

Furthermore, the plant 1 shown in FIG. 1 comprises an open cooling tower 11, via which the pre-cleaned water of the cooling circuit can be cooled. In the cooling tower 11, the pre-cleaned water from the cooling circuit is sprayed such that, among other things, water droplets are formed, which partly evaporate, then condense and cool down in the process. The cooled pre-cleaned water from the cooling circuit then obtained is returned to the hot rolling mill 2 via a main line 12.

Within the cooling circuit 3, the plant 1 further comprises a dosing device 13 for adding bacteria that are suitable for degrading the organic matter present in the water of the cooling circuit. In the present case, the bacteria are formed as lyophilized bacteria. The dosing device 13 can be arranged upstream of the separation device 5, as shown. Alternatively, the dosing device 13 can also be arranged within the separation device 5 upstream of the settling basin 6, upstream of the clarifying basin 7 and/or upstream of the filtration device 8 (not shown).

Nutrients that promote the growth of the added bacteria are also added to the cooling circuit 3 via the dosing device 13. The added nutrients promote the formation of a biocenosis by the bacteria and further favor their long-term existence.

Furthermore, it has proven advantageous if the bacteria are also added to the gravel filter sludge buffer 14, in which the fine scale is collected (not shown), via a further dosing device.

### EXAMPLE

The bacteria used were pure cultures of specially oil-degrading and fat-degrading species with different milieu requirements (anaerobic, anoxic, aerobic), which are available from the applicant under the product name “Oilco-Bacteria.”

Bacteria present in the form of granules were dissolved in water. The granules consist of 1% by weight of the bacteria and 99% by weight of nutrients. The water was initially heated to a temperature comparable to the water of the cooling circuit. Then, the granules were added according to the instructions and the solution was prepared. After a maturing time of 3 to 6 h, the inoculation solution was added to the cooling circuit 3 in a distributed manner via the dosing device 13.

The bacteria added to the water of the cooling circuit have different environmental requirements. The settling basin 6 is anaerobic, the clarifying basin 7 is anaerobic, the filtration device 8 is anoxic aerobic and the cooling tower 11 is aerobic.

Due to the addition of the bacteria, a biocenosis formed in the entire cooling circuit 3 over the course of 2 to 8 weeks. After such incubation period, the biofilms were visibly reduced, which was reflected in the decrease of the legionellae bacterial count from originally over 100 CFU/ml to below 1 CFU/ml.

After the incubation period, to maintain the formed biocenosis, the nutrient concentration was increased and the concentration of newly added bacteria was decreased.

After an additional 6 weeks, a steady state condition was established, such that no resistant biofilms were detected in the cooling circuit 3, which is the breeding ground for legionellae. After an analysis of the water of the cooling circuit according to DIN EN 13098:2018, no legionellae bacterial count could be detected.

The hot rolling mill in which the method was tested produces approximately 1,400 t/a of sludge. Approximately 1,200 t/a of scale was dredged from the settling basin 6 and approximately 200 t/a of fine scale sludge was produced.

The COD content in the supernatant water of the settling basin 6 decreased from the original 60 mg/l to 30 mg/l and in the clarifying basin 7 from 48 mg/l to 6 mg/l.

The organic content of the coarse scale decreased from 280 mg/l to 35 mg/kg. In the fine scale sludge, the organic content amounted to 37% by weight and decreased to 6%.

A phosphate, nitrite, ammonium and nitrate content could not be detected in the water of the cooling circuit due to the detection limit. The pH value decreased due to anaerobic acid formation. As a result, the CaCO3 concentration was reduced, such that hardness, conductivity and salinity decreased. In the settling basin 6, there was a sight depth of approximately 1 m, which did not exist prior to dosing. The cleaning of the filtration units 9, 10, which was carried out regularly prior to dosing, usually monthly, was no longer necessary.

### LIST OF REFERENCE SIGNS

1 Plant
2 Industrial plant/hot rolling mill
3 Cooling circuit
4 Fresh water inlet
5 Separation device
6 Settling basin
7 Clarifying basin
8 Filtration device
9 Filtration unit
10 Filtration unit
11 Cooling tower
12 Main line
13 Dosing device
14 Gravel filter sludge buffer

1.-8. (canceled)

9. A method for eliminating legionellae from water of a cooling circuit of an industrial plant (2), the water being loaded with organic substances and inorganic particles, the method comprising:
passing the water in a cooling circuit (3) through a separation device (5) for separating the organic substances and/or the inorganic particles from the water;
cooling the water by passing the water through an open cooling tower (11) arranged downstream of the separation device (5);
adding bacteria to the water, the bacteria being suitable for degrading the organic substances present in the water; and thereby
forming a biological purification stage within the cooling circuit (3), such that, in a steady state, a legionellae limit value in the water of the cooling circuit of less than 100 CFU/ml is achieved.

10. The method of claim 9,
wherein the industrial plant (2) is a hot rolling mill.

11. The method of claim 9,
wherein the achieved legionellae limit value in the water of the cooling circuit is less than 70 CFU/ml.

12. The method of claim 9,
wherein the achieved legionellae limit value in the water of the cooling circuit is less than 40 CFU/ml.

13. The method of claim 9,
wherein the achieved legionellae limit value in the water of the cooling circuit is less than 10 CFU/ml.

14. The method of claim 9,
wherein the achieved legionellae limit value in the water of the cooling circuit is less than 1 CFU/ml.

15. The method according to claim 9,
wherein the bacteria are added to the water of the cooling circuit upstream of and/or within the separation device (5), and/or upstream of the cooling tower (11).

16. The method according to claim 9, further comprising:
adding nutrients to the water of the cooling circuit upstream of the separation device (5) and/or upstream of the cooling tower (11) to promote growth of the added bacteria.

17. The method according to claim 16, further comprising:
reducing a ratio of added bacteria to added nutrients over time.

18. The method according to claim 16,
wherein the bacteria and/or the nutrients are provided in form of a granulate and/or a suspension and/or are added to the water of the cooling circuit in form of an aqueous solution.

19. The method according to claim 16,
wherein the bacteria and/or the nutrients are provided in form of a granulate and/or a suspension, and
wherein the bacteria in the granulate and/or the suspension are lyophilized bacteria.

20. The method according to claim 9, further comprising
passing the water within the separation device (5) through a settling basin (6), a clarifying basin (7) and/or a filtration purification device (8).

21. The method according to claim 9,
wherein the bacteria have different milieu requirements, namely anaerobic, anoxic and/or aerobic.
